(19) United States
(12) Patent Application Publication
(10) Pub. No.: US 2024/0100728 A1
(43) Pub. Date: Mar. 28, 2024

(54) RECORDING MEDIUM PROCESSING APPARATUS AND IMAGE FORMING SYSTEM

(71) Applicant: FUJIFILM Business Innovation Corp., Tokyo (JP)

(72) Inventors: Hiroaki MOGI, Kanagawa (JP); Shiro Ohashi, Kanagawa (JP); Eiichiro Tokuhiro, Kanagawa (JP); Toshio Fujisawa, Kanagawa (JP)

(73) Assignee: FUJIFILM Business Innovation Corp., Tokyo (JP)

(21) Appl. No.: 18/189,178

(22) Filed: Mar. 23, 2023

(30) Foreign Application Priority Data
Sep. 28, 2022 (JP) 2022-154403

(51) Int. Cl. B26D 7/01; B41J 11/70; B65H 35/00

(52) U.S. Cl. CPC B26D 7/015; B41J 11/70; B65H 35/0086; B26D 2007/005; B65H 2301/122

(57) ABSTRACT

A recording medium processing apparatus includes: a pressing unit that presses one surface of a transported recording medium against a to-be-pressed section; and a cutting unit that cuts the recording medium pressed against the to-be-pressed section.

### CROSS-REFERENCE TO RELATED APPLICATIONS

This application is based on and claims priority under 35 USC 119 from Japanese Patent Application No. 2022-154403 filed Sep. 28, 2022.

### BACKGROUND

### (i) Technical Field

The present disclosure relates to a recording medium processing apparatus and an image forming system.

### (ii) Related Art

Japanese Unexamined Patent Application Publication No. 2019-123627 discloses a correction unit including: a first tilt corrector that corrects the tilt of a transported sheet of paper with respect to the transport direction; and a second tilt corrector that corrects the tilt of the sheet of paper corrected by the first tilt corrector with respect to the transport direction with higher accuracy than that of the first tilt corrector.

### SUMMARY

When a recording medium is cut with the recording medium flexed, the recording medium may be cut at a position not originally intended and the quality of the cutting of the recording medium may reduce.

Aspects of non-limiting embodiments of the present disclosure relate to providing a recording medium processing apparatus that increases the quality of cutting of a recording medium, as compared to when a recording medium is cut with the recording medium not pressed against a to-be-pressed section.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a recording medium processing apparatus including: a pressing unit that presses one surface of a transported recording medium against a to-be-pressed section; and a cutting unit that cuts the recording medium pressed against the to-be-pressed section.

### BRIEF DESCRIPTION OF THE DRAWINGS

Exemplary embodiments of the present disclosure will be described in detail based on the following figures, wherein:

FIG. 1 is a view illustrating the entire configuration of an image forming system;

FIG. 2 is an enlarged view of a sheet processing apparatus;

FIG. 3 is a view of a cutting mechanism as seen from the direction indicated by an arrow III of FIG. 2 and from the rear side of the sheet processing apparatus;

FIG. 4 is an enlarged view when the portion indicated by symbol 4X of FIG. 3 is seen from the direction indicated by an arrow IV;

FIG. 5 is a view illustrating a state of a sheet of paper when an urging member is not provided;

FIGS. 6A and 6B are enlarged views of a lateral side remover;

FIG. 7 is a view when a lateral side remover having no to-be-pressed section is seen;

FIGS. 8A and 8B are views each illustrating another configuration example of a lateral side remover;

FIG. 9 is a view illustrating another configuration example of a lateral side remover; and

FIGS. 10A and 10B are views each illustrating another configuration example of a lateral side remover.

### DETAILED DESCRIPTION

Hereinafter, an exemplary embodiment of the present disclosure will be described in detail with reference to the accompanying drawings.

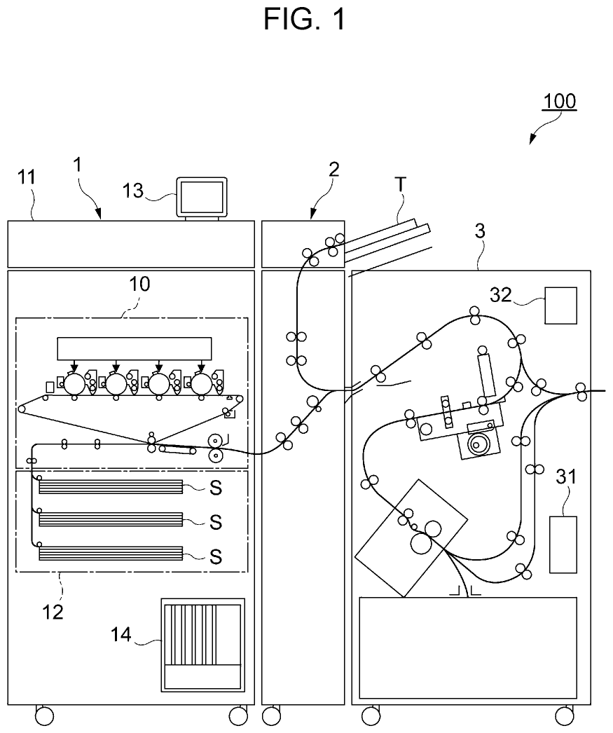

FIG. 1 is a view illustrating the entire configuration of an image forming system 100.

The image forming system 100 according to the exemplary embodiment is provided with: an image forming apparatus 1 that forms an image on sheet of paper S which is an example of a recording medium; sheet of paper feeding apparatus 2 that feeds printed sheet of paper T and colored sheet of paper T; and a sheet of paper processing apparatus 3 that processes the sheet of paper S with an image formed by the image forming apparatus 1, and the sheet of paper T fed by the sheet of paper feeding apparatus 2.

The image forming apparatus 1 is provided with an image former 10 that forms an image on sheet of paper S based on image data. The image former 10 forms an image on sheet of paper S using an existing image forming system such as an ink jet system, and an electrophotographic system.

In addition, the image forming apparatus 1 is provided with an image reader 11 that reads an image formed on a document to generate image data, and a sheet of paper feeder 12 that feeds the sheet of paper S to the image former 10.

In addition, the image forming apparatus 1 is provided with a user interface 13 that receives an operation input from a user, and presents information to the user. The user interface 13 is comprised of a touch panel, for example.

In addition, the image forming apparatus 1 is provided with a main controller 14 that controls the operation of the entire image forming system 100, the major controller 14 including a central processing unit (CPU), and a read only memory (ROM).

In addition to the sheet of paper processing apparatus 3, the image forming system 100 may be provided with the other sheet of paper processing apparatus (not illustrated).

In other words, the image forming system 100 may be provided with the other sheet of paper processing apparatus that processes the sheet of paper S which has passed through the sheet of paper processing apparatus 3.

The other sheet of paper processing apparatus performs, for example, a folding process, a punching process, and a binding process on the sheet of paper S which has passed through the sheet of paper processing apparatus 3.

Note that hereinafter the other sheet of paper processing apparatus is referred to as the “post-processing apparatus” in the present specification.

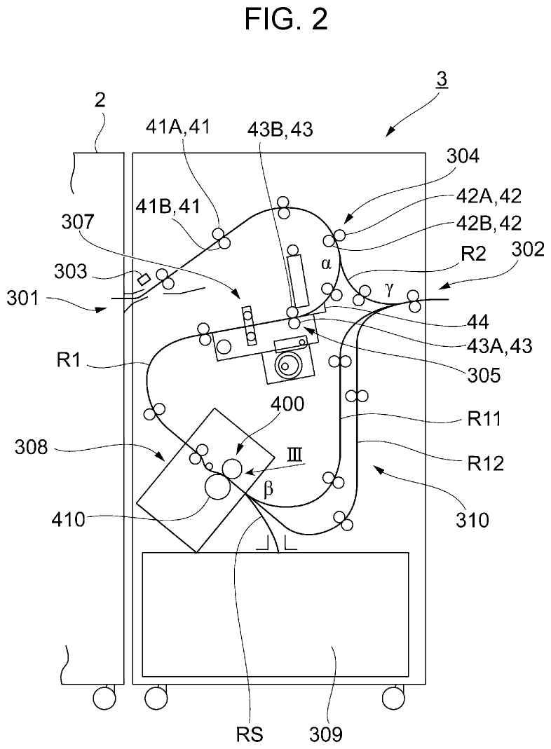

FIG. 2 is an enlarged view of the sheet of paper processing apparatus 3.

The sheet of paper processing apparatus 3 as an example of a recording medium processing apparatus is provided with a crease former 307 that forms a crease on sheet of paper S, and a lateral side remover 308 that removes the lateral sides of the sheet of paper S.

Furthermore, as illustrated in FIG. 1, the sheet of paper processing apparatus 3 includes a CPU, and a ROM, and is provided with a processing controller 31 that controls the functional components of the sheet of paper processing apparatus 3.

In addition, as illustrated in FIG. 1, the sheet of paper processing apparatus 3 is provided with a user interface (UI) 32 that receives, from a user, an operation input related to a process of sheet of paper S. The user interface 32 is comprised of a touch panel, for example.

Note that in the exemplary embodiment, the processing controller 31 is provided in the sheet of paper processing apparatus 3; however, the processing controller 31 may be provided in the image forming apparatus 1. In addition, the major controller 14 may be configured to have the control function of the processing controller 31 as well.

Note that in the exemplary embodiment, the user interface 32 is provided in the sheet of paper processing apparatus 3; however, the user interface 32 may be provided in the image forming apparatus 1. In addition, the user interface 13 may be configured to have the function of the user interface 32 as well.

### <Description of Sheet of Paper Processing Apparatus 3>

As illustrated in FIG. 2, the sheet of paper processing apparatus 3 is provided with a receiving inlet 301 to receive sheet of paper S transported from the image forming apparatus 1, and a discharge outlet 302 to discharge the sheet of paper S.

In addition, the sheet of paper processing apparatus 3 is provided with a tilt detector 303 that detects the tilt of sheet of paper S, and a first tilt corrector 304 including a swing roll 42 that corrects the tilt of sheet of paper S.

In addition, the sheet of paper processing apparatus 3 is provided with a second tilt corrector 305 that has a tilt correction roll 43 which butts against the leading end of sheet of paper S to correct the tilt of the sheet of paper S.

As mentioned above, the sheet of paper processing apparatus 3 is provided with the crease former 307 that forms a crease on sheet of paper S. As mentioned above, the sheet of paper processing apparatus 3 is provided with the lateral side remover 308 that removes the lateral sides of sheet of paper S.

Furthermore, the sheet of paper processing apparatus 3 is provided with a storage section 309 that stores the removed lateral sides.

Furthermore, the sheet of paper processing apparatus 3 is provided with a first sheet of paper transport path R1 along which sheet of paper S passes through. The first sheet of paper transport path R1 is provided from the receiving inlet 301 as a start point to the discharge outlet 302.

The first sheet of paper transport path R1 passes through the tilt detector 303, the first tilt corrector 304, the second tilt corrector 305, the crease former 307, and the lateral side remover 308.

The first sheet of paper transport path R1 branches off at a branch section β located downstream of the lateral side remover 308. Thus, in the exemplary embodiment, part of the first sheet of paper transport path R1 is provided with a first branch path R11 and a second branch path R12.

The first branch path R11 and the second branch path R12 merge at a merge section 7 located forward of the discharge outlet 302.

Furthermore, the sheet of paper processing apparatus 3 is provided with a second sheet of paper transport path R2.

The second sheet of paper transport path R2 is provided to branch from the first sheet of paper transport path R1.

The second sheet of paper transport path R2 branches at a branch section α from the first sheet of paper transport path R1, the branch section a being located downstream of the first tilt corrector 304 and upstream of the crease former 307. The second sheet of paper transport path R2 starts from the branch section α as a start point and extends to the discharge outlet 302.

In the exemplary embodiment, sheet of paper S with no crease formed by the crease former 307, and sheet of paper S with no lateral side removed by the lateral side remover 308 are moved to the discharge outlet 302 through the second sheet of paper transport path R2.

Although illustration is omitted, in the exemplary embodiment, each of the branch section α and the branch section β is provided with a switch member for switching between transport paths to which sheet of paper S is moved.

The first sheet of paper transport path R1, and the second sheet of paper transport path R2 are provided with multiple transport rolls 41 that transport sheet of paper S on these sheets of paper transport paths downstream.

Each transport roll 41 includes a drive roll 41A rotationally driven by a motor, and a driven roll 41B that receives a driving force from the drive roll 41A to be rotated.

The drive roll 41A and the driven roll 41B each have a structure in which multiple cylindrical elastic bodies composed of rubber are attached to a shaft made of metal or the like, for example.

In the transport roll 41, an elastic body provided in the drive roll 41A and an elastic body provided in the driven roll 41B are in a contact state. In this state, in the exemplary embodiment, the drive roll 41A rotates. Accordingly, the driven roll 41B rotates.

When sheet of paper S is inserted between the drive roll 41A and the driven roll 41B, the sheet of paper S receives a force from the drive roll 41A and the driven roll 41B, and is moved downstream.

The tilt detector 303 is provided with two sets of detection members, each of which is formed by a pair of a light emitting device and a light receiving device, for example. The provided two sets of detection members are disposed at different positions in a direction perpendicular to the transport direction of sheet of paper S.

When no sheet of paper S is passing, the light receiving device receives light emitted from the light emitting device.

In the tilt detector 303, each of the two sets of detection members detects the tilt of sheet of paper S based on the timing when the tip end of the sheet of paper S is detected.

When it is detected that the sheet of paper S is tilted, the swing roll 42 is moved according to the amount of tilt of the sheet of paper S detected by the tilt detector 303.

Specifically, in the exemplary embodiment, when it is detected that the sheet of paper S is tilted, first, according to the tilt, the swing roll 42 is in a tilted state.

Then, when the sheet of paper S is pinched by a drive roll 42A and a driven roll 42B provided in the swing roll 42, the drive roll 42A and the driven roll 42B change from a tilted state to a non-tilted state. Consequently, the tilt of the sheet of paper S is corrected.

Here, as in the transport roll 41, the swing roll 42 is also comprised of the drive roll 42A rotationally driven by a motor, and the driven roll 42B that receives a driving force from the drive roll 42A to be rotated.

In the exemplary embodiment, one axial ends of the drive roll 42A and the driven roll 42B are fixed. The other axial ends of the drive roll 42A and the driven roll 42B are moved upstream and downstream in the transport direction of sheet of paper S.

The other axial ends are moved upstream and downstream in the transport direction of sheet of paper S, thereby changing the tilt of the swing roll 42, thus, as described above, the tilt of the sheet of paper S is corrected.

The second tilt corrector 305 further reduces the tilt of the sheet of paper S.

The second tilt corrector 305 includes a correction roll 43 which butts against the leading end of the transported sheet of paper S.

As in the transport roll 41, the correction roll 43 is also comprised of a drive roll 43A rotationally driven by a motor, and a driven roll 43B that receives a driving force from the drive roll 43A to be rotated.

When sheet of paper S butts against the correction roll 43, the correction roll 43 is in a state where rotation thereof is stopped. In this state, the sheet of paper S butts against the correction roll 43, and is further transported, thus the sheet of paper S is flexed.

Subsequently, the rotation of the correction roll 43 is started. Consequently, the sheet of paper S with corrected tilt is transported downstream.

A flexure storage section 44 to store a flexure portion of sheet of paper S is provided upstream of the correction roll 43.

The crease former 307 has an advance member which advances to the first sheet of paper transport path R1 from the side thereof. In the crease former 307, a crease is formed on sheet of paper S by the advance member being pressed against the sheet of paper S.

In the exemplary embodiment, when a folding process is performed by a post-processing apparatus, the advance member advances to a portion of the sheet of paper S, on which the folding process is performed. Thus, a crease is formed on the sheet of paper S. When a crease is formed on the sheet of paper S, the folding process by the post-processing apparatus is performed more smoothly.

A crease is not required to be formed by the crease former 307, and for example, when the folding process is not performed by the post-processing apparatus, a crease may not be formed by the crease former 307.

Alternatively, whether a crease is formed by the crease former 307 may be determined based on instructions from a user, and when a user instructs the crease former 307 not to form a crease, a crease may not be formed.

When no crease is formed by the crease former 307, the sheet of paper S with no crease formed is moved to the lateral side remover 308.

The lateral side remover 308 is a device that performs trimming, and removes the lateral sides of a rectangular-shaped sheet of paper S. More specifically, the lateral side remover 308 removes the lateral sides along the first sheet of paper transport path R1 among four lateral sides of a rectangular-shaped sheet of paper S.

The lateral side remover 308 is provided with a cutting mechanism 400 that cuts sheet of paper S. The cutting mechanism 400 is provided with a disc-shaped rotary blade 410 which is fixed to a shaft extending in a direction perpendicular to the transport direction of sheet of paper S.

Two rotary blades 410 are provided. FIG. 2 illustrates one rotary blade 410 between the two rotary blades 410.

The provided two rotary blades 410 are disposed at different positions in a direction perpendicular to the transport direction of sheet of paper S.

In the exemplary embodiment, these rotary blades 410 cut sheet of paper S to remove the two lateral sides along the first sheet of paper transport path R1 among four lateral sides of the rectangular-shaped sheet of paper S.

Note that both two lateral sides are not necessarily removed, and only one of the two lateral sides may be removed.

Each of the rotary blades 410 is movable in a direction perpendicular to the transport direction of sheet of paper S. In other words, each of the rotary blades 410 is movable in the direction perpendicular to the plane of paper of FIG. 2. Thus, in the exemplary embodiment, even when the size of sheet of paper S is changed, the lateral sides of the sheet of paper S can be removed.

Also, in the exemplary embodiment, since each rotary blade 410 is movable in a direction perpendicular to the transport direction of sheet of paper S, the width of each lateral side to be removed can be adjusted.

In the exemplary embodiment, each lateral side removed is moved to the storage section 309 through a lateral side path RS, and is stored in the storage section 309.

Lateral sides are not required to be removed by the lateral side remover 308, and, for example, when relevant instructions are given by a user, the lateral sides may not be removed.

In other words, whether the lateral sides are removed by the lateral side remover 308 may be determined based on instructions from a user, and when a user instructs the lateral side remover 308 not to remove the lateral sides, no lateral side may be removed.

When no lateral side is removed by the lateral side remover 308, sheet of paper S with no lateral side removed is moved to the discharge outlet 302.

The flow of process in the sheet of paper processing apparatus 3 will be described.

First, the flow of process when sheet of paper S is transported along the first sheet of paper transport path R1 will be described.

In the exemplary embodiment, first, sheet of paper S with an image formed by the image forming apparatus 1 is transported to the sheet of paper processing apparatus 3 (see FIG. 2) through the sheet of paper feeding apparatus 2.

First, in the sheet of paper processing apparatus 3, the tilt of the sheet of paper S is detected by the tilt detector 303. Subsequently, the tilt of the sheet of paper S is corrected by the first tilt corrector 304, and the second tilt corrector 305.

Next, a crease is formed on the sheet of paper S by the crease former 307. Next, the lateral sides of the sheet of paper S are removed by the lateral side remover 308.

Subsequently, the sheet of paper S is delivered to the first branch path R11. The sheet of paper S (hereinafter is referred to as the “preceding sheet of paper S”) is then temporarily stopped on the first branch path R11.

Subsequently, the sheet of paper S (hereinafter is referred to as the “subsequent sheet of paper S”) transported subsequent to the preceding sheet of paper S is delivered to the second branch path R12. The same processes as those for the preceding sheet of paper S are performed on the subsequent sheet of paper S. Specifically, formation of a crease and removal of the lateral sides are performed on the subsequent sheet of paper S.

In the exemplary embodiment, at the timing when the subsequent sheet of paper S is transported to the second branch path R12, the preceding sheet of paper S stopped on the first branch path R11 starts to be transported again. Thus, in the exemplary embodiment, the preceding sheet of paper S and the subsequent sheet of paper S are moved to the discharge outlet 302.

The first branch path R11 has a function as a buffer for holding sheet of paper S, and when a time-consuming process, such as a process of folding bundle of sheets of paper, is performed by the post-processing apparatus, in the exemplary embodiment, as described above, the preceding sheet of paper S is delivered to the first branch path R11.

Then at the timing when the subsequent sheet of paper S is transported to the second branch path R12, the preceding sheet of paper S stopped on the first branch path R11 starts to be transported again, and the preceding sheet of paper S and the subsequent sheet of paper S are transported to the post-processing apparatus.

Here, a case is assumed in which the two branch paths, the first branch path R11 and the second branch path R12 are not provided.

In this case, for the above-mentioned subsequent sheet of paper S, the process to be performed by the sheet of paper processing apparatus 3 cannot be performed immediately, and it is necessary to wait for completion of the process to be performed by the post-processing apparatus, and to start the process to be performed by the sheet of paper processing apparatus 3.

In addition, when the first branch path R11 and the second branch path R12 are not provided, for the above-mentioned subsequent sheet of paper S, it is necessary to wait for completion of the process to be performed by the post-processing apparatus, and to start to form an image in the image forming apparatus 1.

In contrast, when the two branch paths, that is, the first branch path R11 and the second branch path R12 are provided as in the exemplary embodiment, the process to be formed on the subsequent sheet of paper S can be started without waiting for completion of the process to be performed by the post-processing apparatus.

Note that a case has been described in which both two branch paths, that is, the first branch path R11 and the second branch path R12 are used, it is not required to use both these two branch paths.

When a predetermined condition is met, such as when relevant instructions are given from a user, or no process is performed by the post-processing apparatus, sheet of paper S may pass through either one of the first branch path R11 and the second branch path R12.

Alternatively, the two branch paths, that is, the first branch path R11 and the second branch path R12 may not be provided, and only one branch path may be provided.

Next, a case will be described in which sheet of paper S is transported through the second sheet of paper transport path R2.

When a predetermined condition is met, such as when no process is performed by the post-processing apparatus, the sheet of paper S is moved through the second sheet of paper transport path R2 branched from the first sheet of paper transport path R1.

More specifically, for example, when no process is performed by the crease former 307 or no process is performed by the lateral side remover 308, the sheet of paper S is moved through the second sheet of paper transport path R2.

When the sheet of paper S is moved through the second sheet of paper transport path R2, the tilt of the sheet of paper S is detected by the tilt detector 303. The tilt of the sheet of paper S is then corrected by the first tilt corrector 304.

Thus, in this case, the sheet of paper S with corrected tilt is moved to the discharge outlet 302 through the second sheet of paper transport path R2.

Next, the configuration of the lateral side remover 308 will be described.

In the exemplary embodiment, as illustrated in FIG. 2, the lateral side remover 308 is provided with the cutting mechanism 400 as an example of a cutting unit. In the exemplary embodiment, as described above, sheet of paper S is cut by the cutting mechanism 400, and the lateral sides of the sheet of paper S are removed.

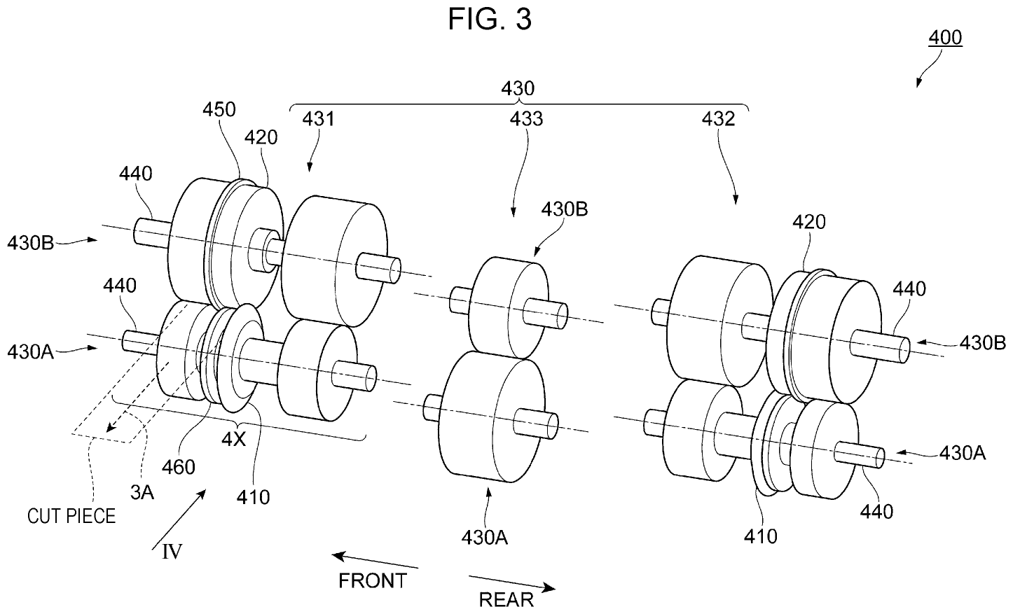

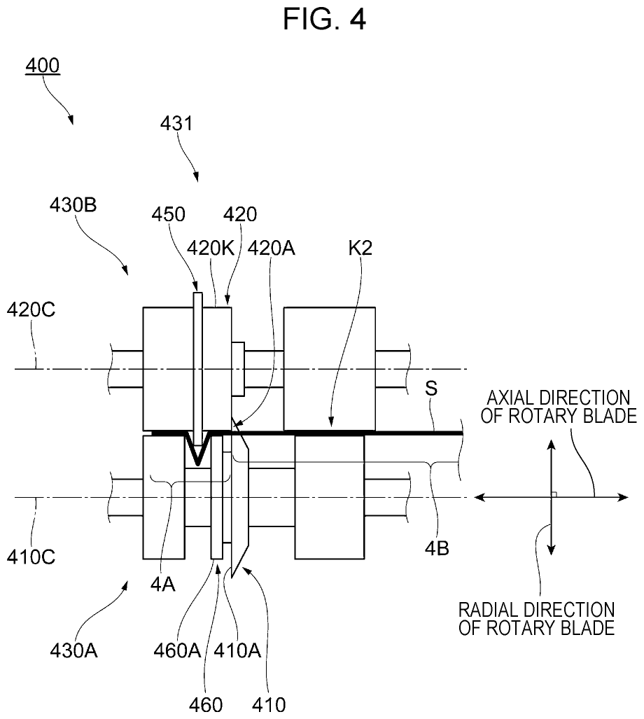

FIG. 3 is a view of the cutting mechanism 400 as seen from the direction indicated by the arrow III of FIG. 2 and from the rear side of the sheet of paper processing apparatus 3. FIG. 4 is an enlarged view when the portion indicated by symbol 4X of FIG. 3 is seen from the direction indicated by the arrow IV.

As illustrated in FIG. 3, FIG. 4, the cutting mechanism 400 is provided with the rotary blades 410 that are formed in a disc shape and rotate. In addition, as illustrated in FIG. 3, FIG. 4, the cutting mechanism 400 is provided with opposed blades 420 that are formed in a disc shape and rotate.

In addition, as illustrated in FIG. 3, the cutting mechanism 400 is provided with a transport roll 430 (hereinafter referred to as a “transport roll 430 for cutting”) that transports sheet of paper S.

Here, the transport roll 430 for cutting is comprised of multiple transport rolls.

In the exemplary embodiment, as the multiple transport rolls, a left-side transport roll 431, a right-side transport roll 432, and a central transport roll 433 are provided.

In the exemplary embodiment, the central transport roll 433 is disposed downstream of the left-side transport roll 431, and the right-side transport roll 432 in the transport direction of sheet of paper S.

Each of the left-side transport roll 431, the right-side transport roll 432, and the central transport roll 433 is comprised of a drive roll 430A rotationally driven by a motor, and a driven roll 430B that receives a driving force from the drive roll 430A to be rotated.

In the same manner as described above, the drive roll 430A and the driven roll 430B each have a structure in which multiple cylindrical elastic bodies composed of rubber are attached to a shaft made of metal or the like, for example.

In the exemplary embodiment, as illustrated in FIG. 3, two pairs of the rotary blade 410 and the opposed blade 420 are provided.

Specifically, in the exemplary embodiment, the first pair of the rotary blade 410 and the opposed blade 420 located on the left side of FIG. 3 to remove one lateral side of the sheet of paper S, and the second pair of the rotary blade 410 and the opposed blade 420 located on the right side of FIG. 3 to remove the other lateral side of the sheet of paper S are provided.

In the exemplary embodiment, the rotary blade 410 of the first pair is disposed coaxially with the drive roll 430A provided in the left-side transport roll 431, and the opposed blade 420 of the first pair is disposed coaxially with the driven roll 430B provided in the left-side transport roll 431.

The rotary blade 410 of the first pair is supported by a shaft 440 of the drive roll 430A provided in the left-side transport roll 431, and the opposed blade 420 of the first pair is supported by a shaft 440 of the driven roll 430B provided in the left-side transport roll 431.

In the exemplary embodiment, the rotary blade 410 of the second pair is disposed coaxially with the drive roll 430A provided in the right-side transport roll 432, and the opposed blade 420 of the second pair is disposed coaxially with the driven roll 430B provided in the right-side transport roll 432.

The rotary blade 410 of the second pair is supported by a shaft 440 of the drive roll 430A provided in the right-side transport roll 432, and the opposed blade 420 of the second pair is supported by a shaft 440 of the driven roll 430B provided in the right-side transport roll 432.

As illustrated in FIG. 4, part of the opposed blade 420 is disposed at an opposed position of one surface 410A of the rotary blade 410. More specifically, in the exemplary embodiment, an outer periphery 420A of the opposed blade 420 is disposed at an opposed position of the one surface 410A of the rotary blade 410.

Note that FIG. 4 illustrates the rotary blade 410, and the opposed blade 420 provided in the left-side transport roll 431, and the rotary blade 410, and the opposed blade 420 provided in the right-side transport roll 432 (see FIG. 3) have the same configuration as that of the rotary blade 410, and the opposed blade 420 provided in the left-side transport roll 431.

As illustrated in FIG. 4, the opposed blade 420 is disposed at a position different from the position of the rotary blade 410 in the axial direction of the rotary blade 410.

In addition, the opposed blade 420 is disposed at a position different from the position of the rotary blade 410 in the radial direction of the rotary blade 410.

In the exemplary embodiment, the rotary blade 410 and the opposed blade 420 are not disposed on the same axis, and a rotational axis 420C of the opposed blade 420 is located at a position away from a rotational axis 410C of the rotary blade 410.

Furthermore, in the exemplary embodiment, as illustrated in FIG. 4, a disc-shaped crease formation member 450 is provided.

The crease formation member 450 is supported by the shaft 440 of the driven 430B provided in the left-side transport roll 431 (see FIG. 3). The crease formation member 450 is disposed coaxially with the opposed blade 420.

In the exemplary embodiment, as illustrated in FIG. 4, the outer diameter of the crease formation member 450 is larger than the outer diameter of the opposed blade 420.

The crease formation member 450 forms a crease along one direction on a cut piece which is moved in the one direction, the cut piece being produced by cutting sheet of paper S by the cutting mechanism 400.

In the exemplary embodiment, a lateral side of the sheet of paper S is removed, thus a cut piece formed of the lateral side is generated. In the exemplary embodiment, the crease formation member 450 is pressed against the cut piece, thus, a crease is formed on the cut piece along the movement direction of the cut piece.

More specifically, in the exemplary embodiment, of the sheet of paper S, the portion indicated by symbol 4A of FIG. 4 is a cut piece. Note that the portion indicated by symbol 4B of FIG. 4 is the sheet of paper body which remains without being cut.

The cut piece is moved in a direction perpendicular to the plane of paper of FIG. 4 and in the near side direction of the plane of paper of FIG. 4. In the exemplary embodiment, the crease formation member 450 is pressed against the cut piece, thus a crease is formed on the cut piece along the movement direction of the cut piece.

Referring to FIG. 3, in the exemplary embodiment, cutting sheet of paper S generates a cut piece which is moved in one direction indicated by symbol 3A in FIG. 3, and in the exemplary embodiment, the crease formation member 450 forms a crease along the one direction on the cut piece which is moved in the one direction.

When a crease is formed on the cut piece along the movement direction of the cut piece, as in the exemplary embodiment, the straight-running stability of the cut piece increases, and the cut piece is unlikely to be moved to a place other than the storage section 309 (see FIG. 2).

In the exemplary embodiment, as illustrated in FIG. 4, an urging member 460 is provided which urges sheet of paper S against the outer peripheral surface of the opposed blade 420.

The urging member 460 is composed of a material harder than rubber, such as polyacetal (POM).

The urging member 460 is supported by the shaft 440 of the drive roll 430A provided in the left-side transport roll 431 (see FIG. 3). In addition, the urging member 460 is formed in a disc shape, and its outer periphery 460A comes into contact with an outer peripheral surface 420K of the opposed blade 420.

In the exemplary embodiment, the crease formation member 450 and the rotary blade 410 are provided on opposite sides with respect to the urging member 460 in the axial direction of the rotary blade 410.

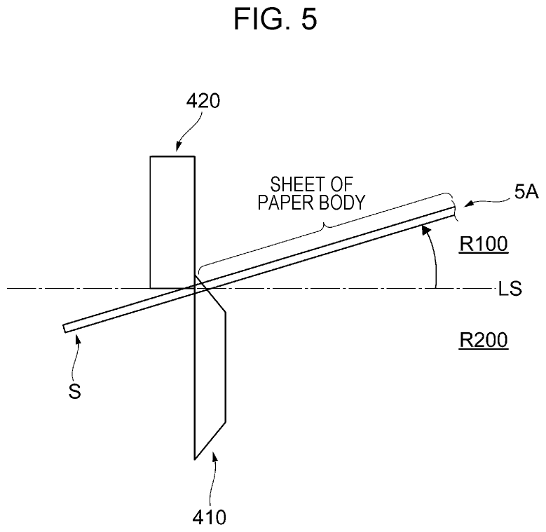

Here, when the urging member 460 is not provided, and sheet of paper S is not pressed against the outer peripheral surface 420K of the opposed blade 420, as indicated by symbol 5A of FIG. 5 (illustrating the state of a sheet of paper when the urging member 460 is not provided), the sheet of paper body is likely to enter a region R100 on the side of the opposed blade 420.

In this case, the sheet of paper S is easily torn off, and the quality of the sheet of paper S after cutting is likely to reduce.

In contrast, as in the exemplary embodiment, when sheet of paper S is pressed against the outer peripheral surface 420K of the opposed blade 420 by the urging member 460 (see FIG. 4), the sheet of paper body is likely to be along a straight line LS passing through the boundary between the region R100 (see FIG. 5) near the opposed blade 420, and a region R200 (see FIG. 5) near the opposed blade 410. Alternatively, the sheet of paper body is likely to be positioned in the region R200 near the opposed blade 410 than on the straight line LS.

In this case, a situation where the sheet of paper S is torn off is unlikely to occur.

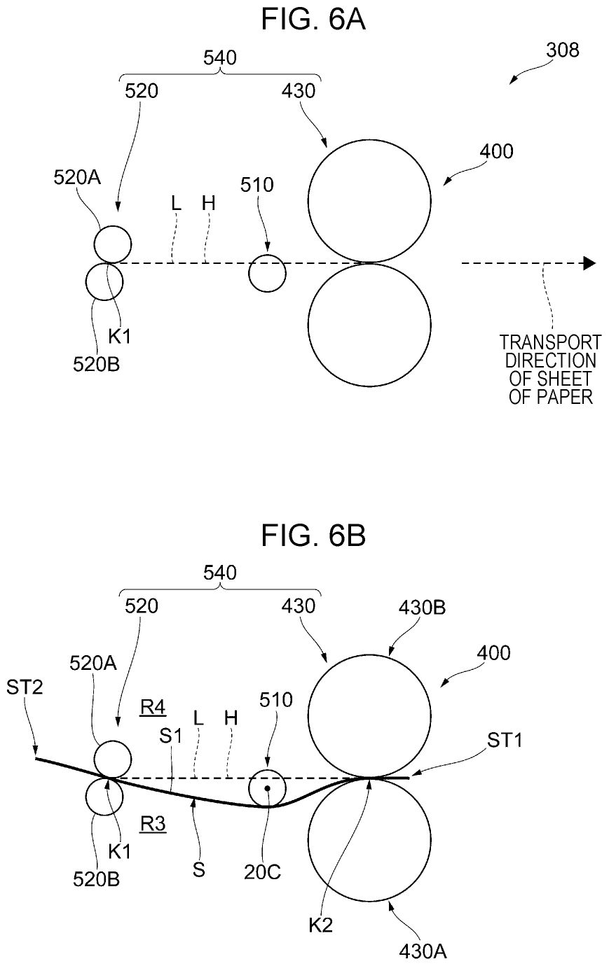

FIGS. 6A and 6B are enlarged views of the lateral side remover 308.

In the exemplary embodiment, as illustrated in FIG. 6A, the lateral side remover 308 is provided with a to-be-pressed section 510 against which one surface of the sheet of paper S (not illustrated in FIG. 6A) is pressed.

The to-be-pressed section 510 is disposed upstream of the cutting mechanism 400 in the transport direction of sheet of paper S.

Furthermore, as illustrated in FIG. 6A, the lateral side remover 308 in the exemplary embodiment is provided with a transport roll 520 (hereinafter referred to as an “upstream transport roll 520”) that is disposed upstream of the to-be-pressed section 510, and transports sheet of paper S downstream.

In the same manner as described above, the upstream transport roll 520 is comprised of a drive roll 520A rotationally driven by a motor, and a driven roll 520B that receives a driving force from the drive roll 520A to be rotated.

Furthermore, in the exemplary embodiment, a pressing mechanism 540 is provided, which is an example of a pressing unit that presses one surface S1 of a transported sheet of paper S (see FIG. 6B) against the to-be-pressed section 510.

The lateral side remover 308 (see FIG. 6A) is provided with multiple transport units that transport sheet of paper S.

Specifically, in the exemplary embodiment, as the multiple transport units, the transport roll 430 for cutting, provided in the cutting mechanism 400, and the upstream transport roll 520 disposed upstream of the to-be-pressed section 510 are provided.

These multiple transport units are disposed at positions displaced from each other in the transport direction of sheet of paper S.

In the exemplary embodiment, the transport speed of sheet of paper S achieved by the upstream transport roll 520 which is an example of one transport unit is surpassed by the transport speed of sheet of paper S achieved by the transport roll 430 for cutting which is an example of another transport unit located downstream of the one transport unit.

Therefore, in the exemplary embodiment, sheet of paper S in a flexed state is pulled, and as illustrated in FIG. 6B, one surface S1 of the sheet of paper S is pressed against the to-be-pressed section 510 located at an opposed position of the one surface S1.

In the exemplary embodiment, sheet of paper S delivered by the upstream transport roll 520 (see FIG. 6B) is not moved straight to the transport roll 430 for cutting.

In the exemplary embodiment, sheet of paper S is configured to be delivered below a straight line L connecting the upstream transport roll 520 and the transport roll 430 for cutting.

In other words, sheet of paper S delivered by the upstream transport roll 520 (see FIG. 6B) is not moved straight to the transport roll 430 for cutting, but is moved below a virtual plane H passing through the upstream transport roll 520 and the transport roll 430 for cutting.

Note that “the transport roll 430 for cutting” herein refers to the left-side transport roll 431 (see FIG. 3) and the right-side transport roll 432 which are positioned downstream of the upstream transport roll 520, and does not include the central transport roll 433 (see FIG. 3).

The straight line L is a line that connects position K1 at which the drive roll 520A and the driven roll 520B provided in the upstream transport roll 520 are in contact, and position K2 at which the drive roll 430A and the driven roll 430B provided in each of the left-side transport roll 431 and the right-side transport roll 432 are in contact.

The plane H is a plane that passes through the position K1 at which the drive roll 520A and the driven roll 520B provided in the upstream transport roll 520 are in contact, and the position K2 at which the drive roll 430A and the driven roll 430B provided in each of the left-side transport roll 431 and the right-side transport roll 432 are in contact, the plane extending along a direction perpendicular to the transport direction of sheet of paper S.

In the exemplary embodiment, sheet of paper S delivered by the upstream transport roll 520 is designed to pass below the straight line L, and the plane H.

The sheet of paper S delivered below the straight line L, and the plane H is guided by a guide member (not illustrated) disposed below the to-be-pressed section 510 to move to the transport roll 430 for cutting. More specifically, the sheet of paper S is guided by the guide member disposed below the to-be-pressed section 510 to move to the transport roll 430 for cutting.

In the exemplary embodiment, at the time when the sheet of paper S reaches the transport roll 430 for cutting, the sheet of paper S is in a flexed state.

In the exemplary embodiment, in this state, the sheet of paper S is pulled by the transport roll 430 for cutting, thus, flexed state of the sheet of paper S gradually reduces, and finally, as illustrated in FIG. 6B, one surface S1 of the sheet of paper S is pressed against the to-be-pressed section 510.

In the exemplary embodiment, the pressing mechanism 540 is comprised of the upstream transport roll 520 and the transport roll 430 for cutting, and one surface S1 of the sheet of paper S is pressed against the to-be-pressed section 510 by the upstream transport roll 520 and the transport roll 430 for cutting.

Note that when sheet of paper S is transported to the upstream transport roll 520, the upstream transport roll 520 may be in a state where rotation thereof is stopped. In this case, the sheet of paper S butts against the upstream transport roll 520 with its rotation stopped, and is further delivered, thereby causing the sheet of paper S to be flexed.

In this case, after the sheet of paper S is flexed, rotation of the upstream transport roll 520 is started. Thus, in this case, the sheet of paper S with its tilt corrected is delivered to the cutting mechanism 400.

In the exemplary embodiment, between one region R3 and the other region R4 opposed to each other across the straight line L (see FIG. 6B) connecting the upstream transport roll 520 and the transport roll 430 for cutting, the sheet of paper S is positioned in the one region R3.

Furthermore, in the exemplary embodiment, at least part of the to-be-pressed section 510 is disposed in the one region R3.

Note that in the exemplary embodiment, part of the to-be-pressed section 510 is disposed in the one region R3; however, all parts of the to-be-pressed section 510 may be disposed in the one region R3.

The to-be-pressed section 510 extends in a direction crossing the transport direction of the transported sheet of paper S. More specifically, the to-be-pressed section 510 extends in a direction perpendicular to the transport direction of the transported sheet of paper S. In other words, the to-be-pressed section 510 extends in the direction perpendicular to the plane of paper of FIGS. 6A and 6B.

In addition, the to-be-pressed section 510 is formed in a cylindrical shape or a column shape, and is rotatable around a rotational shaft 20C (see FIG. 6B) that extends in a direction crossing the transport direction of the sheet of paper S.

In the exemplary embodiment, the pressing mechanism 540 presses one surface S1 of the sheet of paper S against the to-be-pressed section 510 that extends in a direction crossing the transport direction of the sheet of paper S.

In the exemplary embodiment, the to-be-pressed section 510 receives a force from the sheet of paper S pressed against the to-be-pressed section 510. Consequently, the to-be-pressed section 510 follows the sheet of paper S and rotates.

Note that the to-be-pressed section 510 is not required to rotate, and the to-be-pressed section 510 may be provided in a non-rotated state.

In addition, the shape of the to-be-pressed section 510 is not particularly limited, may have a shape other than a cylindrical shape or a column shape. For example, the to-be-pressed section 510 may have a prism shape.

The pressing mechanism 540 pulls one end side of the sheet of paper S in a flexed state in a direction away from the other end side, thereby pressing one surface S1 of the sheet of paper S against the to-be-pressed section 510 located at an opposed position of the one surface S1.

More specifically, the pressing mechanism 540 pulls the front end ST1 side in the transport direction of the sheet of paper S in a direction away from the rear end ST2, thereby pressing the one surface S1 of the sheet of paper S against the to-be-pressed section 510.

In the exemplary embodiment, the to-be-pressed section 510 is disposed to extend along a direction crossing the pulling direction of the sheet of paper S. More specifically, the pressing mechanism 540 is disposed to extend along a direction perpendicular to the pulling direction of the sheet of paper S.

In the exemplary embodiment, the cutting mechanism 400 cuts the sheet of paper S in a state of being pressed against the to-be-pressed section 510.

In the exemplary embodiment, the sheet of paper S is pressed against the to-be-pressed section 510 to reduce the distortion of the sheet of paper S, thus the sheet of paper S with reduced distortion is cut.

In the exemplary embodiment, the cutting mechanism 400 cuts the sheet of paper S along the pulling direction of the sheet of paper S. In the exemplary embodiment, as described above, the front end ST1 side in the transport direction of the sheet of paper S is pulled in a direction away from the rear end ST2, and the sheet of paper S is cut along the pulling direction.

In the exemplary embodiment, the rotary blade 410 (see FIG. 3) is provided along the pulling direction to cut the sheet of paper S along the pulling direction.

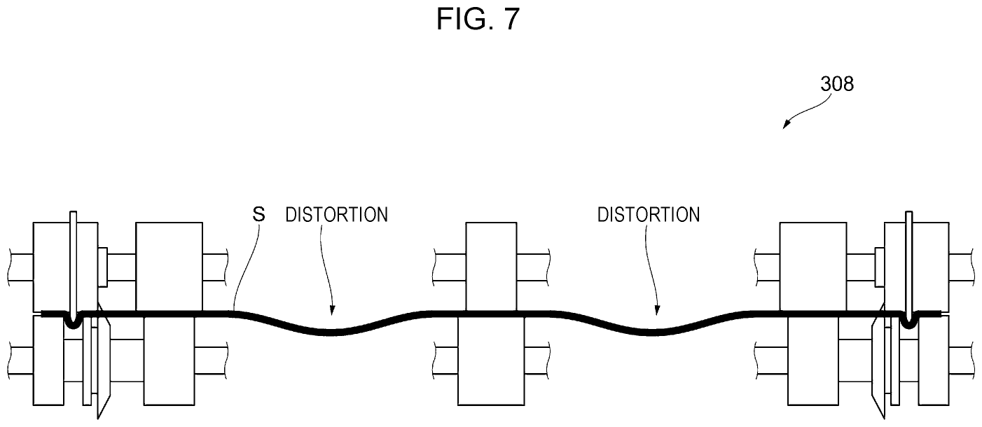

FIG. 7 is a view when the lateral side remover 308 having no to-be-pressed section 510 is seen. FIG. 7 illustrates a state of the lateral side remover 308 when viewed from downstream in the transport direction of sheet of paper S.

As illustrated in FIG. 7, in the lateral side remover 308, distortion may occur in the sheet of paper S. When the sheet of paper S is cut in this state, the sheet of paper S is cut at a position not originally intended.

In contrast, when sheet of paper S is pressed against the to-be-pressed section 510 which extends along a direction crossing the transport direction of the sheet of paper S as in the exemplary embodiment, the distortion of the sheet of paper S is reduced, and the possibility of cutting at a position originally intended is increased.

Note that in the exemplary embodiment, a case has been described where sheet of paper S is cut along the transport direction of the sheet of paper S; however, the direction of cutting is not particularly limited, and for example, the sheet of paper S may be cut along a direction crossing the transport direction of the sheet of paper S.

In other words, in the exemplary embodiment, a case has been described where sheet of paper S is cut along the pulling direction of the sheet of paper S; however, the sheet of paper S may be cut along a direction crossing the pulling direction of the sheet of paper S.

When sheet of paper S is cut along a direction crossing the transport direction of the sheet of paper S, a cutting blade extending in the crossing direction is advanced to the sheet of paper S, or the rotary blade 410 is moved to the crossing direction, for example. Thus, the sheet of paper S can be cut along the crossing direction.

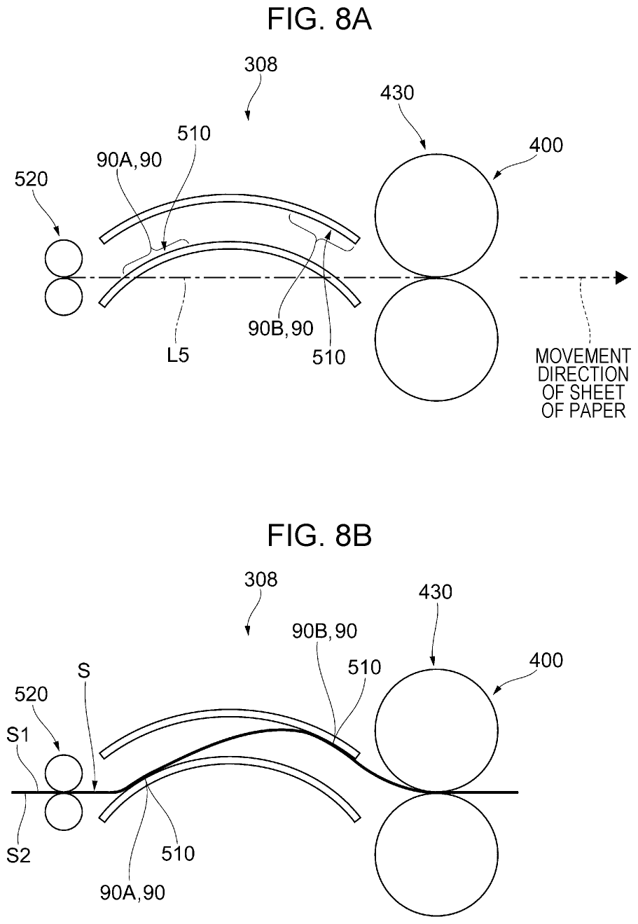

FIGS. 8A and 8B are views each illustrating another configuration example of the lateral side remover 308.

In this configuration example, as illustrated in FIG. 8A, the to-be-pressed section 510 is comprised of an inclined surface 90 that is disposed laterally of the transport path of sheet of paper S, and inclined to the movement direction of the transported sheet of paper S.

In this configuration example, the upstream transport roll 520 functioning as a pressing unit transports the sheet of paper S to the inclined surface 90, and as illustrated in FIG. 8B, presses a surface of the sheet of paper S against the inclined surface 90 which is the to-be-pressed section 510. Thus, in the same manner as described above, the distortion of the sheet of paper S is reduced.

In the configuration example illustrated in FIGS. 8A and 8B, the inclined surface 90 is provided above straight line L5 (see FIG. 8A) connecting the upstream transport roll 520 and the transport roll 430 for cutting.

In addition, in this configuration example, multiple inclined surfaces 90 are provided. The provided multiple inclined surfaces 90 are disposed at different positions in the transport direction of sheet of paper S.

In addition, each of the inclined surfaces 90 is provided to extend in a direction crossing the transport direction of sheet of paper S. In other words, each of the inclined surfaces 90 is provided to extend in the direction perpendicular to the plane of paper of FIGS. 8A and 8B.

In the exemplary embodiment, when sheet of paper S is cut by the cutting mechanism 400, as illustrated in FIG. 8B, the sheet of paper S is in a state of being pressed against the multiple inclined surfaces 90.

In the exemplary embodiment, among the multiple inclined surfaces 90 provided, an upstream inclined surface 90A which is one inclined surface 90 positioned upstream is disposed on the side of the other surface S2 of the transported sheet of paper S.

A downstream inclined surface 90B which is the other inclined surface 90 positioned downstream is disposed on the side of one surface S1 of the sheet of paper S.

In the exemplary embodiment, when sheet of paper S is cut by the cutting mechanism 400, the one surface S1 of the sheet of paper S is in a state of being pressed against the downstream inclined surface 90B, and the other surface S2 of the sheet of paper S is in a state of being pressed against the upstream inclined surface 90A.

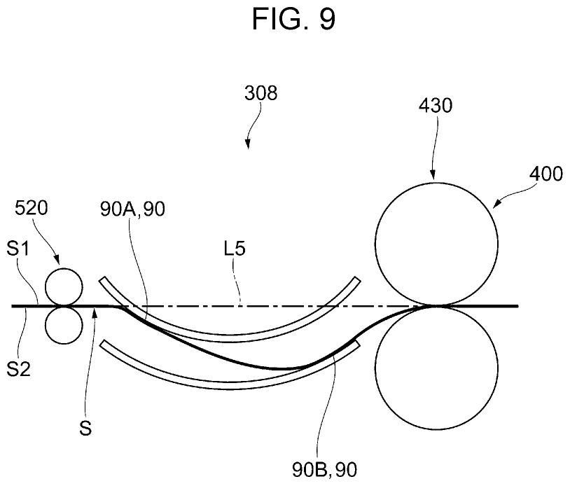

FIG. 9 is a view illustrating another configuration example of the lateral side remover 308.

In this configuration example illustrated in FIG. 9, the inclined surface 90 is provided below the straight line L5 connecting the upstream transport roll 520 and the transport roll 430 for cutting.

In this configuration example, among the multiple inclined surfaces 90 provided, the upstream inclined surface 90A positioned upstream is disposed on the side of the one surface S1 of the transported sheet of paper S, and the downstream inclined surface 90B positioned downstream is disposed on the side of the other surface S2 of the transported sheet of paper S.

In this configuration example, when sheet of paper S is cut by the cutting mechanism 400, the one surface S1 of the sheet of paper S is in a state of being pressed against the upstream inclined surface 90A, and the other surface S2 of the sheet of paper S is in a state of being pressed against the downstream inclined surface 90B.

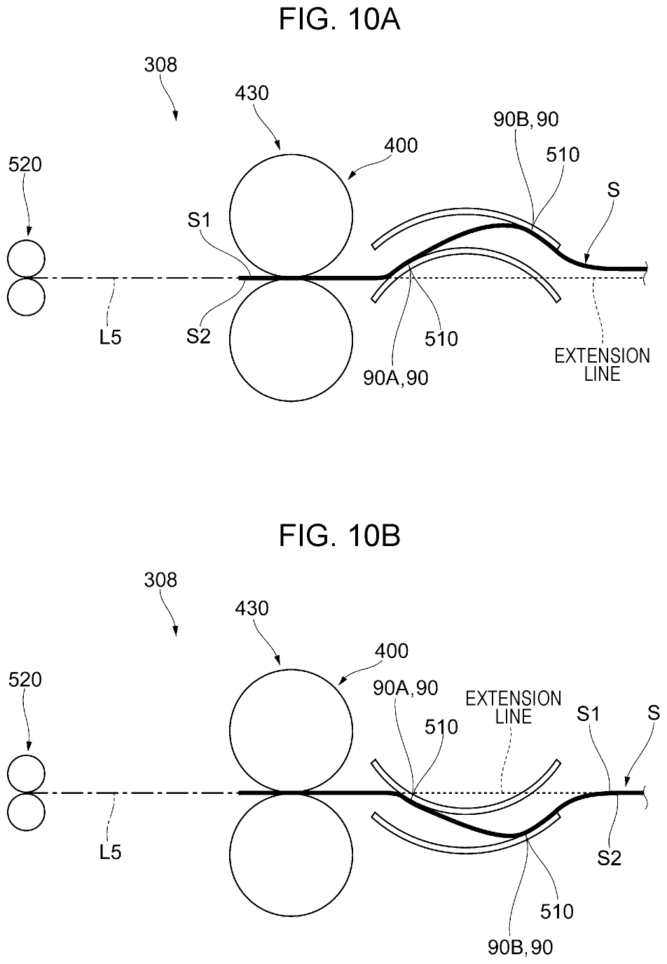

FIGS. 10A and 10B are views each illustrating another configuration example of the lateral side remover 308.

In this configuration example, the to-be-pressed section 510 is disposed downstream of the cutting mechanism 400 in the transport direction of sheet of paper S.

Like this configuration example, even when the to-be-pressed section 510 is disposed downstream of the cutting mechanism 400, the distortion of sheet of paper S is reduced, and the sheet of paper S with reduced distortion is cut by the cutting mechanism 400.

In this configuration example, the transport roll 430 for cutting functioning as a pressing unit transports sheet of paper S to the inclined surface 90 positioned downstream of the cutting mechanism 400, and presses a surface of the sheet of paper S against the inclined surface 90 which is the to-be-pressed section 510. Thus, in the same manner as described above, the distortion of the sheet of paper S is reduced.

Also, in the configuration example illustrated in FIG. 10A, multiple inclined surfaces 90 are provided. In the same manner as described above, the provided multiple inclined surfaces 90 are disposed at different positions in the transport direction of sheet of paper S.

In addition, in this configuration example, the inclined surfaces 90 are provided above the extension line of the straight line L5 connecting the upstream transport roll 520 and the transport roll 430 for cutting.

Also, in the configuration example, when sheet of paper S is cut by the cutting mechanism 400, the sheet of paper S is in a state of being pressed against the multiple inclined surfaces 90.

Specifically, in this configuration example, when sheet of paper S is cut by the cutting mechanism 400, the other surface S2 of the sheet of paper S is in a state of being pressed against the upstream inclined surface 90A, and the one surface S1 of the sheet of paper S is in a state of being pressed against the downstream inclined surface 90B.

FIG. 10B is a view illustrating another configuration example of the lateral side remover 308.

Also, in this configuration example, the to-be-pressed section 510 is disposed downstream of the cutting mechanism 400 in the transport direction of the transported sheet of paper S.

Also, in this configuration example, the transport roll 430 for cutting functioning as a pressing unit transports sheet of paper S to the inclined surface 90, and presses a surface of the sheet of paper S against the inclined surface 90 which is the to-be-pressed section 510. Thus, in the same manner as described above, the distortion of the sheet of paper S is reduced.

Also, in the configuration example illustrated in FIG. 10B, multiple inclined surfaces 90 are provided. In the same manner as described above, the provided multiple inclined surfaces 90 are disposed at different positions in the transport direction of sheet of paper S.

In addition, in this configuration example, the inclined surfaces 90 are provided below the extension line of the straight line L5 connecting the upstream transport roll 520 and the transport roll 430 for cutting.

Also, in this configuration example, when sheet of paper S is cut by the cutting mechanism 400, the sheet of paper S is in a state of being pressed against the multiple inclined surfaces 90.

Specifically, in this configuration example, when sheet of paper S is cut by the cutting mechanism 400, the one surface S1 of the sheet of paper S is in a state of being pressed against the upstream inclined surface 90A, and the other surface S2 of the sheet of paper S is in a state of being pressed against the downstream inclined surface 90B.

Note that in the configuration examples illustrated in FIGS. 8A and 8B, and FIG. 9, the transport speed of sheet of paper S achieved by the upstream transport roll 520 may be greater than the transport speed of sheet of paper S achieved by the transport roll 430 for cutting. In this case, the contact pressure between the upstream inclined surface 90A and the sheet of paper S, and the contact pressure between the downstream inclined surface 90B and the sheet of paper S are both increased.

Alternatively, in the configuration examples illustrated in FIGS. 8A and 8B, and FIG. 9, the transport speed of sheet of paper S achieved by the upstream transport roll 520 may be equal to the transport speed of sheet of paper S achieved by the transport roll 430 for cutting.

Alternatively, in the configuration examples illustrated in FIGS. 8A and 8B, and FIG. 9, the transport speed of sheet of paper S achieved by the transport roll 430 for cutting may be greater than the transport speed of sheet of paper S achieved by the upstream transport roll 520. In this case, although the downstream inclined surface 90B and the sheet of paper S become less likely to be in contact with each other, the contact pressure between the upstream inclined surface 90A and the sheet of paper S is increased.

Also, in FIGS. 8A and 8B to FIGS. 10A and 10B, cases have been described where sheet of paper S is pressed against multiple inclined surfaces 90; however, the sheet of paper S is not required to be pressed against multiple inclined surfaces 90, and the sheet of paper S may be cut by the cutting mechanism 400 with the sheet of paper S pressed against one inclined surface 90.

In the configuration example illustrated in FIGS. 6A and 6B, a case where the to-be-pressed section 510 is disposed upstream of the cutting mechanism 400 has been described as an example; however, the to-be-pressed section 510 may be disposed downstream of the cutting mechanism 400.

Alternatively, the to-be-pressed section 510 may be disposed both upstream and downstream of the cutting mechanism 400.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A recording medium processing apparatus comprising:
a pressing unit that presses one surface of a transported recording medium against a to-be-pressed section; and
a cutting unit that cuts the recording medium pressed against the to-be-pressed section.

(((2)))

The recording medium processing apparatus according to (((1))),
wherein the pressing unit presses the one surface of the recording medium against the to-be-pressed section which extends in a direction crossing a transport direction of the recording medium transported.

(((3)))

The recording medium processing apparatus according to (((2))),
wherein the to-be-pressed section is formed in a cylindrical shape or a column shape, and is provided rotatably around a rotational shaft which extends in the crossing direction.

(((4)))

The recording medium processing apparatus according to (((1))),
wherein the pressing unit pulls one end side of the recording medium in a flexed state in a direction away from the other end side so as to press the one surface of the recording medium against the to-be-pressed section located at an opposed position of the one surface.

(((5)))

The recording medium processing apparatus according to (((4))),
wherein the to-be-pressed section is disposed to extend along a direction crossing a pulling direction of the recording medium.

(((6)))

The recording medium processing apparatus according to (((5))),
wherein the cutting unit cuts the recording medium along the pulling direction of the recording medium.

(((7)))

The recording medium processing apparatus according to (((1))), further comprising
a plurality of transport units that transport a recording medium, the plurality of transport units being disposed at positions displaced from each other in a transport direction of the recording medium,
wherein a transport speed of recording material achieved by one of the plurality of transport units is surpassed by a transport speed of recording material achieved by the other transport unit located downstream of the one transport unit so that a recording medium in a flexed state is pulled, and one surface of the recording medium is pressed against the to-be-pressed section located at an opposed position of the one surface.

(((8)))

The recording medium processing apparatus according to (((7))),
wherein between one region and the other region opposed to each other across a straight line connecting the one transport unit and the other transport unit, the recording medium in a flexed state is positioned in the one region, and
at least part of the to-be-pressed section is disposed in the one region.

(((9)))

The recording medium processing apparatus according to (((1))),
wherein the to-be-pressed section is an inclined surface that is disposed laterally of a transport path of a recording medium, and inclined to a movement direction of the recording medium, and
the pressing unit transports the recording medium to the inclined surface, and presses one surface of the recording medium against the inclined surface that is the to-be-pressed section.

(((10)))

The recording medium processing apparatus according to (((9))),
wherein a plurality of inclined surfaces, each of which is the inclined surface, are provided, and disposed at different positions in a transport direction of a recording medium, and
when a recording medium is cut by the cutting unit, the recording medium is in a state of being pressed against the plurality of inclined surfaces.

(((11)))

The recording medium processing apparatus according to (((10))),
wherein one of the plurality of inclined surfaces provided is disposed on one surface of a recording medium transported, other inclined surfaces are disposed on the other surface of the recording medium, and
when a recording medium is cut by the cutting unit, one surface of the recording medium is in a state of being pressed against the one inclined surface, and the other surface of the recording medium is in a state of being pressed against the other inclined surfaces.

(((12)))

The recording medium processing apparatus according to any one of (((1))) to (((11))),
wherein in a transport direction of the recording medium transported, the to-be-pressed section is disposed upstream of the cutting unit.

(((13)))

The recording medium processing apparatus according to any one of (((1))) to (((12))),
wherein in a transport direction of the recording medium transported, the to-be-pressed section is disposed downstream of the cutting unit.

(((14)))

The recording medium processing apparatus according to any one of (((1))) to (((13))), wherein the cutting unit includes:
a rotary blade configured to rotate;
an opposed blade disposed at a position different from a position of the rotary blade in an axial direction of the rotary blade, disposed at a position different from a position of the rotary blade in a radial direction of the rotary blade, and disposed at an opposed position of one surface of the rotary blade in part, the opposed blade being configured to rotate; and
an urging member that urges the recording medium to be cut against an outer peripheral surface of the opposed blade.

(((15)))

The recording medium processing apparatus according to (((14))),
wherein the cutting unit further includes:
a crease formation member that is disposed coaxially with the opposed blade, and forms a crease along one direction on a cut piece which is moved in the one direction, the cut piece being produced by cutting a recording medium by the cutting unit.

(((16)))

An image forming system comprising: an image forming apparatus that forms an image on a recording medium; a recording medium processing apparatus that processes the recording medium with an image formed by the image forming apparatus; and the recording medium processing apparatus is comprised of the recording medium processing apparatus according to any one of (((1))) to (((15))).

What is claimed is:

1. A recording medium processing apparatus comprising:
a pressing unit that presses one surface of a transported recording medium against a to-be-pressed section; and
a cutting unit that cuts the recording medium pressed against the to-be-pressed section.

2. The recording medium processing apparatus according to claim 1,
wherein the pressing unit presses the one surface of the recording medium against the to-be-pressed section which extends in a direction crossing a transport direction of the recording medium transported.

3. The recording medium processing apparatus according to claim 2,
wherein the to-be-pressed section is formed in a cylindrical shape or a column shape, and is provided rotatably around a rotational shaft which extends in the crossing direction.

4. The recording medium processing apparatus according to claim 1,
wherein the pressing unit pulls one end side of the recording medium in a flexed state in a direction away from the other end side so as to press the one surface of the recording medium against the to-be-pressed section located at an opposed position of the one surface.

5. The recording medium processing apparatus according to claim 4,
wherein the to-be-pressed section is disposed to extend along a direction crossing a pulling direction of the recording medium.

6. The recording medium processing apparatus according to claim 5,
wherein the cutting unit cuts the recording medium along the pulling direction of the recording medium.

7. The recording medium processing apparatus according to claim 1, further comprising:
a plurality of transport units that transport a recording medium, the plurality of transport units being disposed at positions displaced from each other in a transport direction of the recording medium,
wherein a transport speed of a recording medium achieved by one of the plurality of transport units is surpassed by a transport speed of a recording material achieved by the other transport unit located downstream of the one transport unit so that a recording medium in a flexed state is pulled, and one surface of the recording medium is pressed against the to-be-pressed section located at an opposed position of the one surface.

8. The recording medium processing apparatus according to claim 7,
wherein between one region and the other region opposed to each other across a straight line connecting the one transport unit and the other transport unit, the recording medium in a flexed state is positioned in the one region, and
at least part of the to-be-pressed section is disposed in the one region.

9. The recording medium processing apparatus according to claim 1,
wherein the to-be-pressed section is an inclined surface that is disposed laterally of a transport path of a recording medium, and inclined to a movement direction of the recording medium, and
the pressing unit transports the recording medium to the inclined surface, and presses one surface of the recording medium against the inclined surface that is the to-be-pressed section.

10. The recording medium processing apparatus according to claim 9,
wherein a plurality of inclined surfaces, each of which is the inclined surface, are provided, and disposed at different positions in a transport direction of a recording medium, and
when a recording medium is cut by the cutting unit, the recording medium is in a state of being pressed against the plurality of inclined surfaces.

11. The recording medium processing apparatus according to claim 10,
wherein one of the plurality of inclined surfaces provided is disposed on one surface of a recording medium transported, other inclined surfaces are disposed on the other surface of the recording medium, and
when a recording medium is cut by the cutting unit, one surface of the recording medium is in a state of being pressed against the one inclined surface, and the other surface of the recording medium is in a state of being pressed against the other inclined surfaces.

12. The recording medium processing apparatus according to claim 1,
wherein in a transport direction of the recording medium transported, the to-be-pressed section is disposed upstream of the cutting unit.

13. The recording medium processing apparatus according to claim 1,
wherein in a transport direction of the recording medium transported, the to-be-pressed section is disposed downstream of the cutting unit.

14. The recording medium processing apparatus according to claim 1,
wherein the cutting unit includes:
a rotary blade configured to rotate;
an opposed blade disposed at a position different from a position of the rotary blade in an axial direction of the rotary blade, disposed at a position different from a position of the rotary blade in a radial direction of the rotary blade, and disposed at an opposed position of one surface of the rotary blade in part, the opposed blade being configured to rotate; and
an urging member that urges the recording medium to be cut against an outer peripheral surface of the opposed blade.

15. The recording medium processing apparatus according to claim 14,
wherein the cutting unit further includes a crease formation member that is disposed coaxially with the opposed blade, and forms a crease along one direction on a cut piece which is moved in the one direction, the cut piece being produced by cutting a recording medium by the cutting unit.

16. An image forming system comprising:
an image forming apparatus that forms an image on a recording medium; and
a recording medium processing apparatus that processes the recording medium with an image formed by the image forming apparatus; the recording medium processing apparatus being comprised of the recording medium processing apparatus according to claim 1.

17. An image forming system comprising:
an image forming apparatus that forms an image on a recording medium; and
a recording medium processing apparatus that processes a recording medium with an image formed by the image forming apparatus; the recording medium processing apparatus being comprised of the recording medium processing apparatus according to claim 2.

18. An image forming system comprising:
an image forming apparatus that forms an image on a recording medium; and
a recording medium processing apparatus that processes a recording medium with an image formed by the image forming apparatus; the recording medium processing apparatus being comprised of the recording medium processing apparatus according to claim 3.

19. An image forming system comprising:
an image forming apparatus that forms an image on a recording medium; and
a recording medium processing apparatus that processes a recording medium with an image formed by the image forming apparatus; the recording medium processing apparatus being comprised of the recording medium processing apparatus according to claim 4.

20. An image forming system comprising:
an image forming apparatus that forms an image on a recording medium; and
a recording medium processing apparatus that processes a recording medium with an image formed by the image forming apparatus; and the recording medium processing apparatus being comprised of the recording medium processing apparatus according to claim 5.
